(19) United States
(12) Patent Application Publication
(10) Pub. No.: US 2024/0286632 A1
(43) Pub. Date: Aug. 29, 2024

(54) RECOMMENDATION SYSTEM

(71) Applicant: TOYOTA JIDOSHA KABUSHIKI KAISHA, Toyota-shi Aichi-ken (JP)

(72) Inventor: Wataru KAWASHIMA, Nisshin-shi Aichi (JP)

(73) Assignee: TOYOTA JIDOSHA KABUSHIKI KAISHA, Toyota-shi Aichi-ken (JP)

(21) Appl. No.: 18/586,026

(22) Filed: Feb. 23, 2024

(30) Foreign Application Priority Data
Feb. 28, 2023 (JP) 2023-029411

(51) Int. Cl. B60W 50/14; B60W 40/08; B60W 50/00; B60W 50/08; G06V 20/59; G06V 40/16

(52) U.S. Cl. CPC B60W 50/14; B60W 40/08; B60W 50/082; G06V 20/59; G06V 40/172; B60W 2040/0809; B60W 2050/0083; B60W 2050/143; B60W 2050/146; B60W 2420/403; B60W 2540/043

(57) ABSTRACT

A recommendation system includes an operation detection unit configured to detect an override operation by a driver; a scene acquisition unit configured to acquire an override scene when the override operation is detected; a function selection unit configured to select a driving assistance function corresponding to the override scene among driving assistance functions not activated, based on the acquired override scene; and a proposal unit configured to propose to the driver whether or not to activate the selected driving assistance function.

### CROSS-REFERENCE TO RELATED APPLICATIONS

This application is based upon and claims the benefit of priority from Japanese Patent Application No. 2023-029411, filed on Feb. 28, 2023, the entire contents of which are incorporated herein by reference.

### BACKGROUND

### Field

The present disclosure relates to a recommendation system that proposes the activation of a driving assistance function to a driver of a vehicle.

### Description of the Related Art

Various driving assistance functions for an assistance to the traveling of a vehicle, such as an automatic lane change function and a lane keeping function, have been proposed. For example, Japanese Unexamined Patent Publication No. 20018-092538 describes the above-described automatic lane change function.

### SUMMARY

Various driving assistance functions have been proposed; however, not all the functions are considered to be necessary by a driver of a vehicle according to the present disclosure. If these driving assistance functions are uniformly activated or inactivated, driving assistance functions considered to be unnecessary by the driver may become activated, or driving assistance functions considered to be necessary by the driver may become inactivated.

For this reason, the present disclosure describes a recommendation system capable of proposing whether or not to activate a driving assistance function more appropriate for a driver.
[1] According to one aspect of the present disclosure, “there is provided a recommendation system configured to propose an activation of a driving assistance function to a driver of a vehicle, the system including: an operation detection unit configured to detect an override operation by the driver with respect to an operation of the driving assistance function; a scene acquisition unit configured to acquire an override scene when the override operation is detected; a function selection unit configured to select a driving assistance function corresponding to the override scene among driving assistance functions not activated, based on the acquired override scene; and a proposal unit configured to propose to the driver whether or not to activate the selected driving assistance function.”

Here, a case where the override operation is performed by the driver is considered to be a case where the driver wants the vehicle to perform an operation different from the driving assistance function in operation or does not desire the driving assistance function in operation. For this reason, the recommendation system is triggered by when the override operation by the driver is detected, to select the driving assistance function corresponding to the override scene when the override operation is detected. Accordingly, the recommendation system can select the driving assistance function more appropriate for the driver among the driving assistance functions that are not activated. In such a manner, the recommendation system can propose whether or not to activate the driving assistance function more appropriate for the driver by selecting the driving assistance function corresponding to the override scene.
[2] According to the recommendation system described in [1], “in the recommendation system, the proposal unit may be configured to propose to the driver whether or not to inactivate the driving assistance function for which a detection state of the override operation by the operation detection unit satisfies a predetermined detection state.” In this case, the recommendation system can more appropriately propose not only the activation of the driving assistance function but also the inactivation of the driving assistance function to the driver.
[3] According to the recommendation system described in [1] or [2], “the recommendation system may further include a function adjustment unit configured to adjust an assistance content of the driving assistance function selected by the function selection unit, based on the override operation detected by the operation detection unit. The proposal unit may be configured to propose to the driver whether or not to activate the driving assistance function adjusted by the function adjustment unit.” In this case, the recommendation system can adjust the assistance content of the driving assistance function to a content more appropriate for the driver. Furthermore, the recommendation system can propose whether or not to activate the driving assistance function with an assistance content more appropriate for the driver.
[4] According to the recommendation system described in any one of [1] to [3], “the recommendation system may further include a driver recognition unit configured to recognize the driver; and an individual information storage unit configured to store identification information of the driver and the driving assistance functions not activated in association with each other for each driver. The function selection unit may be configured to select the driving assistance function corresponding to the override scene among the driving assistance functions not activated and corresponding to the driver recognized by the driver recognition unit, based on information stored in the individual information storage unit.” In this case, even when the driver of the vehicle is changed, the recommendation system can propose whether or not to activate the driving assistance functions not activated, depending on the driver riding in the vehicle.

According to one aspect of the present disclosure, it is possible to propose whether or not to activate a driving assistance function more appropriate for the driver.

### BRIEF DESCRIPTION OF THE DRAWINGS

FIG. 1 is a block diagram showing one example of a recommendation system according to an embodiment.

FIG. 2 is a flowchart showing the flow of a process of proposing the activation of a driving assistance function performed by the recommendation system.

### DETAILED DESCRIPTION

In the following description, with reference to the drawings, the same reference numbers are assigned to the same components or to similar components having the same function, and overlapping description is omitted.

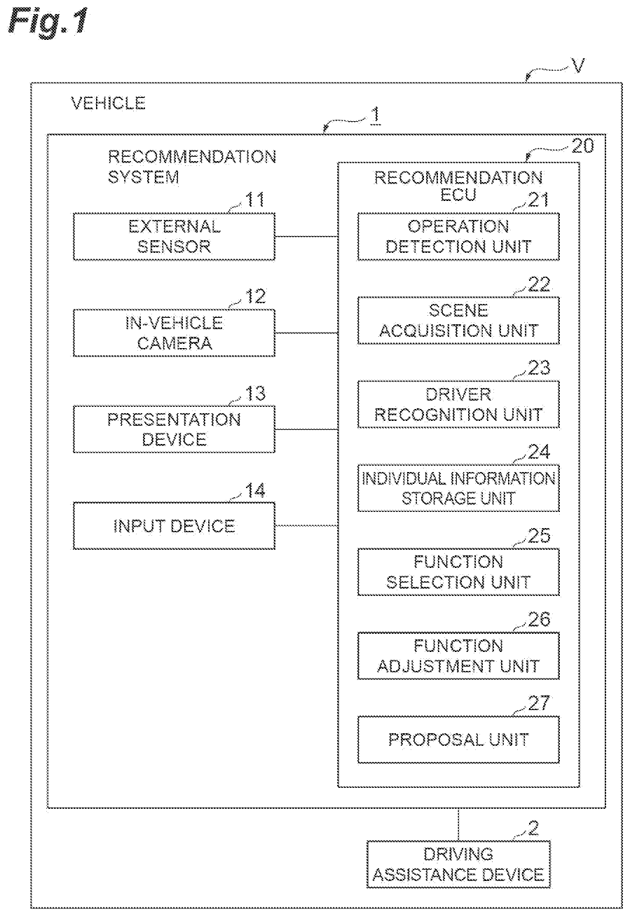

A driving assistance device 2 capable of executing various driving assistance functions such as an automatic lane change function and a lane keeping function is installed in a vehicle V shown in FIG. 1. The driving assistance device 2 executes an activated driving assistance function among the driving assistance functions installed in the vehicle V. The vehicle V may be an automated driving vehicle capable of traveling automatically. A recommendation system 1 proposes the activation of driving assistance functions, which are not activated in the driving assistance device 2, to a driver of the vehicle V.

The recommendation system 1 is installed in the vehicle V. The recommendation system 1 includes an external sensor 11, an in-vehicle camera 12, a presentation device 13, an input device 14, and a recommendation electronic control unit (ECU) 20. The external sensor 11 is an on-vehicle sensor that detects an external environment of the vehicle V. For example, the external sensor 11 includes at least one of a camera that captures an image of the environment of the vehicle V and a light detection and ranging (LIDAR).

The in-vehicle camera 12 is a camera that captures an image of the driver in the vehicle V. The presentation device 13 is a device that presents information to the driver of the vehicle V. The presentation device 13 includes, for example, at least one of an on-vehicle display and a speaker. The input device 14 is a device that receives an input operation by the driver. For example, the input device 14 may be a switch, a touch panel, or the like.

The recommendation ECU 20 is an electronic control unit including a central processing unit (CPU), a read only memory (ROM), a random access memory (RAM), and the like. The recommendation ECU 20 realizes various functions by, for example, loading a program stored in the ROM into the RAM and by executing the program loaded in the RAM through the CPU. The recommendation ECU 20 may be made up of a plurality of electronic units. The recommendation ECU 20 functionally includes an operation detection unit 21, a scene acquisition unit 22, a driver recognition unit 23, an individual information storage unit 24, a function selection unit 25, a function adjustment unit 26, and a proposal unit 27.

The operation detection unit 21 detects an override operation performed by the driver with respect to an operation of the driving assistance function executed by the driving assistance device 2. The operation detection unit 21 can acquire information about which driving assistance function is under execution from the driving assistance device 2. The operation detection unit 21 can detect the override operation based on the detection results of various sensors that detect a driving operation by the driver. As the sensors that detect the driving operation by the driver, for example, an accelerator pedal sensor that detects operation of an accelerator pedal, a brake pedal sensor that detects operation of a brake pedal, a steering sensor that detects operation of a steering wheel, a winker sensor that detects operation of a winker lever, and the like can be used.

The scene acquisition unit 22 acquires an override scene when the override operation is detected by the operation detection unit 21. Here, the override scene includes at least one of a situation when the override operation is detected and an operation content when the driver performs the override operation. The situation when the override operation is detected may include a state of the vehicle V or may include a situation around the vehicle V. The scene acquisition unit 22 can acquire the state of the vehicle V based on the detection results of various sensors (for example, a vehicle speed sensor, an acceleration sensor, and the like) that detect a traveling state of the vehicle V. In addition, the scene acquisition unit 22 may acquire the state of the vehicle V based on a control command value or the like when the driving assistance device 2 controls the traveling of the vehicle V. The scene acquisition unit 22 can acquire the situation around the vehicle V based on the detection result of the external sensor 11. In addition, the scene acquisition unit 22 may acquire the operation content when the driver performs the override operation from the operation detection unit 21 that detects the override operation, or may acquire the operation content based on the detection results of various sensors that detect the driving operation by the driver similarly to the operation detection unit 21.

The driver recognition unit 23 recognizes a driver riding in the vehicle V. Here, the driver recognition unit 23 identifiably recognizes the driver. For example, the driver recognition unit 23 can recognize (identify) the driver based on the captured image of the in-vehicle camera 12 using a known image processing technique.

Here, although will be described in detail later, the driver activates a driving assistance function based on a proposal from the recommendation system 1. Namely, the activated driving assistance function differs for each driver. The individual information storage unit 24 stores identification information of the driver and driving assistance functions not activated for the driver in association with each other for each driver identified by the driver recognition unit 23. For example, the individual information storage unit 24 may acquire, from the driving assistance device 2, information about whether or not which driving assistance function is activated for each driver.

The function selection unit 25 selects a driving assistance function corresponding to the acquired override scene among the driving assistance functions that are not activated, based on the override scene acquired by the scene acquisition unit 22. As described above, the individual information storage unit 24 stores driving assistance functions not activated for each driver. For this reason, here, the function selection unit 25 selects a driving assistance function corresponding to the override scene among the driving assistance functions not activated and corresponding to the driver recognized by the driver recognition unit 23, based on information stored in the individual information storage unit 24.

Here, the override scene may include a situation when the override operation is detected. In this case, the function selection unit 25 selects, among the driving assistance functions that are not activated, a driving assistance function determined in advance for the situation when the override operation is detected. For example, there is a driving assistance function that is considered to enable the behavior of the vehicle V to conform to a behavior along an intention of the driver by being executed in the situation when the override operation is detected. Such a driving assistance function is set as the driving assistance function determined in advance for the situation when the override operation is detected. In addition, for example, there is a driving assistance function that allows the vehicle V to travel more appropriately by being executed in the situation when the override operation is detected. Such a driving assistance function is set as the driving assistance function determined in advance for the situation when the override operation is detected.

Further, the override scene may include an operation content when the driver performs the override operation. In this case, the function selection unit 25 selects, among the driving assistance functions that are not activated, a driving assistance function in which the behavior of the vehicle V caused by executing the driving assistance function is closest to (highly coincides with) a behavior caused by the operation content of the override operation.

The function adjustment unit 26 adjusts the assistance content of the driving assistance function selected by the function selection unit 25, based on the override operation detected by the operation detection unit 21. Here, for example, the function adjustment unit 26 adjusts the assistance content such that the behavior of the vehicle V caused by executing the selected driving assistance function becomes closer to the behavior caused by the operation content of the override operation. For example, the function adjustment unit 26 can adjust the timing of steering, the amount of change in steering angle (change speed), the strength and actuation timing of brakes, the stopping position of the vehicle V when the vehicle V is stopped, the strength of acceleration, and the like as the content to be adjusted.

The function adjustment unit 26 is not limited to adjusting the assistance contents of all the driving assistance functions selected by the function selection unit 25. For example, the function adjustment unit 26 may be configured not to perform adjustment on driving assistance functions determined in advance. Accordingly, the recommendation system 1 can maintain the state of initial assistance contents set in advance for the driving assistance functions determined in advance.

The proposal unit 27 proposes to the driver of the vehicle V whether or not to activate the driving assistance function selected by the function selection unit 25. When the function adjustment unit 26 adjusts the assistance content of the driving assistance function, the proposal unit 27 proposes to the driver whether or not to activate the driving assistance function of which the assistance content is adjusted by the function adjustment unit 26. Here, the proposal unit 27 can propose the assistance content using the presentation device 13. For example, the proposal unit 27 can propose whether or not to activate the driving assistance function using at least one of the on-vehicle display and the speaker of the presentation device 13.

The proposal unit 27 is not limited to making a proposal using the presentation device 13 installed in the vehicle V. For example, the proposal unit 27 can propose to the driver whether or not to activate the driving assistance function using a presentation device different from the on-vehicle devices. For example, the proposal unit 27 can make a proposal using a communication device (notification or the like through an electronic mail or an application) such as a mobile terminal as the presentation device different from the on-vehicle devices.

The proposal unit 27 receives, via the input device 14, an input operation performed by the driver as to whether or not to activate the driving assistance function. When the proposal unit 27 receives an input operation to activate the proposed driving assistance function, the proposal unit 27 instructs the driving assistance device 2 to activate the driving assistance function. Accordingly, the driving assistance device 2 activates the instructed driving assistance function. When the assistance content of the driving assistance function is adjusted by the function adjustment unit 26, the proposal unit 27 instructs the driving assistance device 2 with information about the assistance content that is adjusted, together with an instruction to activate the driving assistance function. In addition, the proposal unit 27 may receive an instruction as to whether or not to activate the driving assistance function based on an input operation to a communication device such as a mobile terminal, in addition to using the input device 14.

In addition, the proposal unit 27 can propose not only the activation of the driving assistance function but also the inactivation of the driving assistance function that is activated. Here, the proposal unit 27 proposes to the driver whether or not to inactivate a driving assistance function for which the detection state of the override operation by the operation detection unit 21 satisfies a predetermined detection state. For example, when the operation detection unit 21 detects the override operation a predetermined number of times or more within a predetermined period, the proposal unit 27 can propose to the driver whether or not to inactivate the driving assistance function.

The proposal unit 27 is not limited to proposing the inactivation of all driving assistance functions for which the detection state of the override operation satisfies the predetermined detection state. The proposal unit 27 may be configured not to propose the inactivation of a driving assistance function determined in advance even when the detection state of the override operation satisfies the predetermined detection state. Accordingly, the recommendation system 1 can maintain the activated state of the driving assistance function determined in advance.

The proposal unit 27 receives, via the input device 14, an input operation as to whether or not to inactivate the driving assistance function. When the proposal unit 27 receives an input operation to inactivate the proposed driving assistance function, the proposal unit 27 instructs the driving assistance device 2 to inactivate the driving assistance function. Accordingly, the driving assistance device 2 inactivates the instructed driving assistance function. In addition, the proposal unit 27 may receive an instruction as to whether or not to inactivate the driving assistance function based on an input operation to a communication device such as a mobile terminal, in addition to using the input device 14.

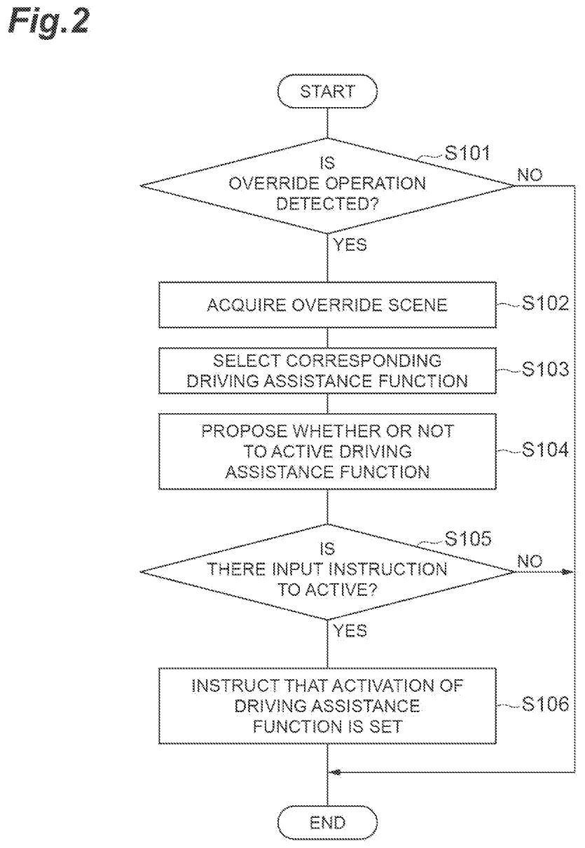

Next, the flow of a process of proposing the activation of a driving assistance function, which is performed in the recommendation system 1, will be described using FIG. 2. The execution of the process shown in FIG. 2 is started after the vehicle V becomes able to travel. In addition, when the process reaches the end, the process is started from the start after a predetermined time. As shown in FIG. 2, the operation detection unit 21 determines whether or not an override operation by the driver is detected (S101). Here, the operation detection unit 21 determines whether or not the override operation by the driver is currently detected. When it is determined that the override operation is not detected (S101: NO), the recommendation system 1 executes the process from the start again after a predetermined time.

On the other hand, when it is determined that the override operation is detected (S101: YES), the scene acquisition unit 22 acquires an override scene when the override operation is detected (S102). Next, as described above, the function selection unit 25 selects a driving assistance function to be proposed to the driver among driving assistance functions that are not activated (S103). The proposal unit 27 proposes to the driver of the vehicle V whether or not to activate the driving assistance function selected by the function selection unit 25 (S104).

After the activation is proposed, the proposal unit 27 determines whether or not the driver performs an input operation to activate the proposed driving assistance function (S105). Here, the proposal unit 27 determines whether or not the input operation is performed for a period determined in advance. When the input operation to activate is not performed (S105: NO), the recommendation system 1 executes the process from the start again after a predetermined time. On the other hand, when the input operation to activate is performed (S105: YES), the proposal unit 27 instructs the driving assistance device 2 to activate the driving assistance function proposed to the driver (S106). Accordingly, the driving assistance device 2 sets the instructed driving assistance function to an activated state.

As described above, the recommendation system 1 proposes whether or not to activate the driving assistance function corresponding to the override scene among the driving assistance functions that are not activated. Here, a case where the override operation is performed by the driver is considered to be a case where the driver wants the vehicle V to perform an operation different from the driving assistance function in operation or does not desire the driving assistance function in operation. For this reason, the recommendation system 1 is triggered by when the override operation by the driver is detected, to select the driving assistance function corresponding to the override scene when the override operation is detected. Accordingly, the recommendation system 1 can select the driving assistance function more appropriate for the driver among the driving assistance functions that are not activated. In such a manner, the recommendation system 1 can propose whether or not to activate the driving assistance function more appropriate for the driver by selecting the driving assistance function corresponding to the override scene.

The recommendation system 1 can propose to the driver whether or not to inactivate the driving assistance function for which the detection state of the override operation satisfies the predetermined detection state. In this case, the recommendation system 1 can more appropriately propose not only the activation of the driving assistance function but also the inactivation of the driving assistance function to the driver.

The recommendation system 1 includes the function adjustment unit 26 that adjusts the assistance content of the driving assistance function selected by the function selection unit 25, based on the override operation. In this case, the recommendation system 1 can adjust the assistance content of the driving assistance function to a content more appropriate for the driver. Furthermore, the recommendation system 1 can propose whether or not to activate the driving assistance function with an assistance content more appropriate for the driver.

The recommendation system 1 includes the individual information storage unit 24 that stores the driving assistance functions not activated for each driver. Furthermore, the function selection unit 25 selects the driving assistance function corresponding to the override scene among the driving assistance functions not activated and corresponding to the driver recognized by the driver recognition unit 23, based on information stored in the individual information storage unit 24. The proposal unit 27 proposes whether or not to activate the selected driving assistance function. In this case, even when the driver of the vehicle V is changed, the recommendation system 1 can propose whether or not to activate the driving assistance functions not activated, depending on the driver riding in the vehicle V.

The embodiment of the present disclosure has been described above; however, the present disclosure is not limited to the embodiment. For example, some of the functions of the recommendation system 1 may be installed in a server or the like other than the vehicle V. In this case, various information may be transmitted and received by performing communication via wireless communication or the like between the vehicle V and the server. For example, the function selection unit 25 of the recommendation system 1 may be provided in a server or the like outside the vehicle. In this case, for example, the function selection unit 25 provided outside the vehicle may not know about what driving assistance functions are installed in the vehicle V. Furthermore, the function selection unit 25 provided outside the vehicle may select a driving assistance function according to the override scene as long as the driving assistance function can be executed by the vehicle V even if the driving assistance function is not currently installed in the vehicle V. Furthermore, the proposal unit 27 proposes to the driver of the vehicle V whether or not to activate the driving assistance function selected by the function selection unit 25 provided outside the vehicle. In this case, the recommendation system 1 can propose whether or not to activate a driving assistance function more appropriate for the driver even when the driving assistance function is not currently installed in the vehicle V. Functional units other than the function selection unit 25 described above may be provided in a server or the like outside the vehicle.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. A recommendation system configured to propose an activation of a driving assistance function to a driver of a vehicle, the system comprising:
an operation detection unit configured to detect an override operation by the driver with respect to an operation of the driving assistance function;
a scene acquisition unit configured to acquire an override scene when the override operation is detected;
a function selection unit configured to select a driving assistance function corresponding to the override scene among driving assistance functions not activated, based on the acquired override scene; and
a proposal unit configured to propose to the driver whether or not to activate the selected driving assistance function.

2. The recommendation system according to claim 1,
wherein the proposal unit is configured to propose to the driver whether or not to inactivate the driving assistance function for which a detection state of the override operation by the operation detection unit satisfies a predetermined detection state.

3. The recommendation system according to claim 1, further comprising:
a function adjustment unit configured to adjust an assistance content of the driving assistance function selected by the function selection unit, based on the override operation detected by the operation detection unit,
wherein the proposal unit is configured to propose to the driver whether or not to activate the driving assistance function adjusted by the function adjustment unit.

4. The recommendation system according to claim 1, further comprising:
a driver recognition unit configured to recognize the driver; and
an individual information storage unit configured to store identification information of the driver and the driving assistance functions not activated in association with each other for each driver,
wherein the function selection unit is configured to select the driving assistance function corresponding to the override scene among the driving assistance functions not activated and corresponding to the driver recognized by the driver recognition unit, based on information stored in the individual information storage unit.
